(19) United States
(12) Patent Application Publication
(10) Pub. No.: US 2009/0292914 A1
(43) Pub. Date: Nov. 26, 2009

(54) NODES AND SYSTEMS AND METHODS FOR DISTRIBUTING GROUP KEY CONTROL MESSAGE

(75) Inventors: Ya Liu, Shenzhen (CN); Xiao Liang, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/533,735

(22) Filed: Jul. 31, 2009

Related U.S. Application Data
(63) Continuation of application No. PCT/CN2008/070165, filed on Jan. 22, 2008.

(30) Foreign Application Priority Data
Feb. 1, 2007 (CN) 200710002826.1

(51) Int. Cl. H04L 9/08; H04L 29/06

(52) U.S. Cl. 713/153; 380/279

(57) ABSTRACT

Nodes, systems and methods for distributing a group key control message are disclosed. The system mainly includes a root node and child nodes. The apparatus includes a distribution tree establishment node. The method mainly includes: establishing a distribution tree for the group key control message in the group key management system, a root node delivering the group key control message to the child nodes according to the distribution tree; the child nodes receiving the group key control message delivered from the root node, forwarding or locally processing the received group key control message. With the present disclosure, a replication/distribution mechanism for the group key control message is established within the group key management system, thereby eliminating the dependence of the group key management system on the deployed environment multicast service, and improving the availability and expansibility of the group key management system.

### CROSS REFERENCE

The present application claims priority of CN 200710002826.1, filed on Feb. 1, 2007, entitled “Nodes, and systems and methods for distributing group key control message”, and PCT/CN2008/070165, filed on Jan. 22, 2008, entitled “Nodes, and systems and methods for distributing group key control message”, all of which are entirely incorporated herein by references.

### FIELD OF THE INVENTION

Embodiments of the present disclosure relate to the field of network communications, and more particularly, to nodes, systems and methods for distributing a group key control message.

### BACKGROUND

Multi-party communication refers to a communication scenario participated by two or more members, which is a particular instance of the multi-party communication. The multi-party communication scenario generally has multiple data receivers, and one or more data dispatchers. The unicast technique or multicast technique may be employed to transmit messages in the multi-party communication. The multi-party communication may be achieved more easily by using the multicast technique than the unicast technique.

The common multi-party communication scenarios include the remote multi-party conference, IP telephone, IPTV, online games, grid computing, etc. The multi-party communication security refers to providing access control (authorization, authentication) for the members of the multi-party communication group (the participators of the multi-party communication), and providing secure services such as encryption, integrity protection, replay protection, source authentication and group authentication, etc., for the communication content, thereby preventing a non-group member to bug or tamper the communication content, disturb the normal proceeding of the communication process, as well as preventing the security threat from internal of the multi-party communication group. Therefore, the multi-party communication group is also referred to as a secure group.

The multi-party communication security mainly includes:

1. Authorization and Authentication. Only those being permitted and with provable identities may join the multi-party communication group and transmit and receive data, so as to make the multicast group controllable.

2. Keeping Secret. Only those nodes having the group key may interpret the content of the group communication messages.

3. Group Member Authentication. Non-group members cannot generate the valid authentication information, thus are unable to transmit a multicast message by masquerading a group member.

4. Source Authentication (Anti-Denying). A group member cannot generate the authentication information of another group member, thus is unable to transmit a multicast message by masquerading another group member. Moreover, a group member may not deny the information it has transmitted.

5. Anonymity. A mechanism of speaking anonymously is provided for the group members, that is, the receiver is unable to infer the identity of the dispatcher from the received multicast message.

6. Integrity. A means for determining whether the received multicast message has been tampered is provided.

7. Anti-Replay. A replay detection mechanism is provided to achieve the anti-replay attacks.

To ensure the security of the multi-party communication, the multi-party communication messages are usually transmitted in encryption. The group key used for encrypting and decrypting the multi-party communication messages are only known to the group members, so as to ensure that the encrypted messages may be interpreted only by the group members. The group member authentication may also be implemented by utilizing the group key, since only the group members having this group key may generate an encrypted multicast message properly.

The essential for addressing the security problem of multi-party communication by using the group key is the generation and distribution of the group key. Such generation and distribution must be exclusive, i.e., the non-group members are unable to obtain the generated and distributed group key. The source authentication, integrity and anonymity services would also use the exclusive sharing of information between two or multiple parties. In the multi-party communication, how to implement the exclusive sharing of the group key is in the study field of the group key management. The group key is a key shared by all the group members, and may be used to perform secure operations such as encrypting and decrypting the multicast messages. The group key server mainly generates, issues, and updates the group key for the group members by a group key control message.

The first method for distributing the group key control message in the prior art is: achieving the distribution of the group key control message by terms of unicast. This method is relatively simple, and readily to be implemented.

In implementing the embodiments of the present disclosure, the inventors find that the disadvantage of the first method for distributing the group key control message in the prior art is that: the group key server or group members need to transmit the group key control message for many times, and therefore the group key server is with low efficiency and with poor expansibility, and relatively significant delay is brought for the group key distribution or group key negotiation.

The second method for distributing the group key control message in the prior art is: achieving the distribution of the group key control message by terms of multicast. Presently, the common multicast ways include the link layer multicast, the IP multicast, and the application layer multicast, etc.

In implementing the embodiments of the present disclosure, the inventors find that the disadvantage of the second method for distributing the group key control message in the prior art is that: the link layer multicast service may be provided readily for the link layer techniques implemented essentially by the multicast technique, such as the Ethernet, the wireless local area network, etc. However, such multicast service is often limited within some local area network, and the multicast service across local area networks may not be realized. However, the IP multicast can rarely provide the IP multicast service across networks due to the difficulty of actual deployment. The application layer multicast service is in study so far, without a mature standard and is rarely deployed. From the foregoing description for the multicast service, there is practical difficulty in implementing the group key distribution with the existing multicast.

### SUMMARY

Various embodiments of the present disclosure provide nodes, and systems and methods for distributing a group key control message, so as to solve the disadvantages of inefficiency and poor expansibility of the group key server, eliminating the dependence of the group key management system on the deployed environment multicast service, and the relatively significant distribution delay of the group key control message.

The embodiments of the invention are achieved by the following technical schemes:

A system for distributing a group key control message includes: a root node (12), configured to deliver the group key control message to a child node according to a distribution tree for the group key control message; and a child node (13), configured to receive the group key control message delivered from the root node and process the received group key control message.

A method for distributing a group key control message includes establishing a distribution tree for the group key control message. The method further includes: delivering, by a root node, the group key control message to a child node according to the distribution tree; and receiving, by the child node, the group key control message delivered from the root node and processing the received group key control message.

A node for managing a distribution tree for a group key control message includes: a distribution tree establishment module (14), configured to select a root node and child nodes for the distribution tree, determine identity and location of each child node within the distribution tree, inform identity and location information of a respective child node to the child node and other child nodes related to the child node, and establish the distribution tree according to the identity and location information of all the child nodes; and a distribution tree maintenance module (15), configured to perform a maintenance operation on the distribution tree, the maintenance operation including at least one of deleting a child node, adding a child node, and adjusting location of a child node.

A node for distributing a group key control message includes: a location information acquisition module (31), configured to acquire location information of the node and its neighboring nodes within a distribution tree for the group key control message; and a process module (32), configured to process the group key control message according to the location information obtained by the location information acquisition module.

As seen from the technical schemes above provided by the embodiments of the invention, the embodiments of the disclosure establish and maintain a distribution tree in the group key management system, the root node, backbone nodes and leaf nodes distribute the group key control message according to the distribution tree. Therefore, a replication/distribution mechanism for the group key control message is established within the group key management system, thereby eliminating the dependence of the group key management system on the deployed environment multicast service, avoiding the inefficiency caused in implementing the “1 to more” distribution of the group key control message by employing the unicast technique, and improving the availability and expansibility of the group key management system.

### BRIEF DESCRIPTION OF THE DRAWING(S)

FIG. 1 is a block diagram of a system according to an embodiment of the disclosure;

FIG. 2 is a block diagram of an embodiment of a distribution tree according to an embodiment of the disclosure;

FIG. 3 is a schematic block diagram of a node provided by an embodiment of the disclosure;

FIG. 4 is a processing flowchart of a method according to an embodiment of the disclosure;

FIG. 5 is a block diagram of a distribution tree in a specific application instance of a system according to an embodiment of the disclosure;

FIG. 6 is a block diagram of an adjusted distribution tree in a specific application instance of a system according to an embodiment of the disclosure; and

FIG. 7 is a block diagram of a distribution tree in another specific application instance of a system according to an embodiment of the disclosure.

### DETAILED DESCRIPTION

The embodiments of the present disclosure provide nodes, systems and methods for distributing a group key control message. The software corresponding to the embodiments of the invention may be stored in a computer readable storage medium.

According to the generation of group keys, the group key management methods may be classified into two categories: the centralized management group key management method and the distributed negotiation group key management method, which are introduced below respectively.

In the centralized management group key management method, the group key is created, updated and distributed by a dedicated group key server. The group key server encrypts the group key before distributing the group key, so as to prevent the leakage of the group key. The key used to encrypt the group key is referred to as KEK (Key Encryption Key, an assistant key). There is only one group key shared by all the group members, while the assistant keys include a plurality of keys. The group key server shares different assistant keys with different group members, respectively.

During the distribution of the group key, the group key server selects respective KEKs according to different group members to encrypt the group key, so as to control the access of the group members to the group key, thereby achieving the need of the forward and backward encryption and authorized access. The group key server will generate a plurality of different encrypted messages after encrypting the group key with different KEKs. For simplifying the management for the encrypted messages, the group key server typically packs all the encrypted messages into a group key distribution message and sends it to the respective group members.

In the distributed negotiation group key management method, the group key is negotiated in a cryptology manner by all the group members who are equal. Before the negotiation of the group key, each group member initially generates a secret value only known to itself, cryptographically transforms this secret value and then sends a message carrying the transformation result (usually also referred to as contribution value) to the other group members. After all the group members send their own contribution values and receive the contribution values sent from other group members, each group member calculates the group key independently. The group members calculate and obtain the group key shared by all the group members by substituting the contribution values of all the group members into a particular cryptology formula.

The group key distribution message in the centralized management group key management method and the message carrying the contribution values in the distributed negotiation group key management method are collectively referred to as group key control message.

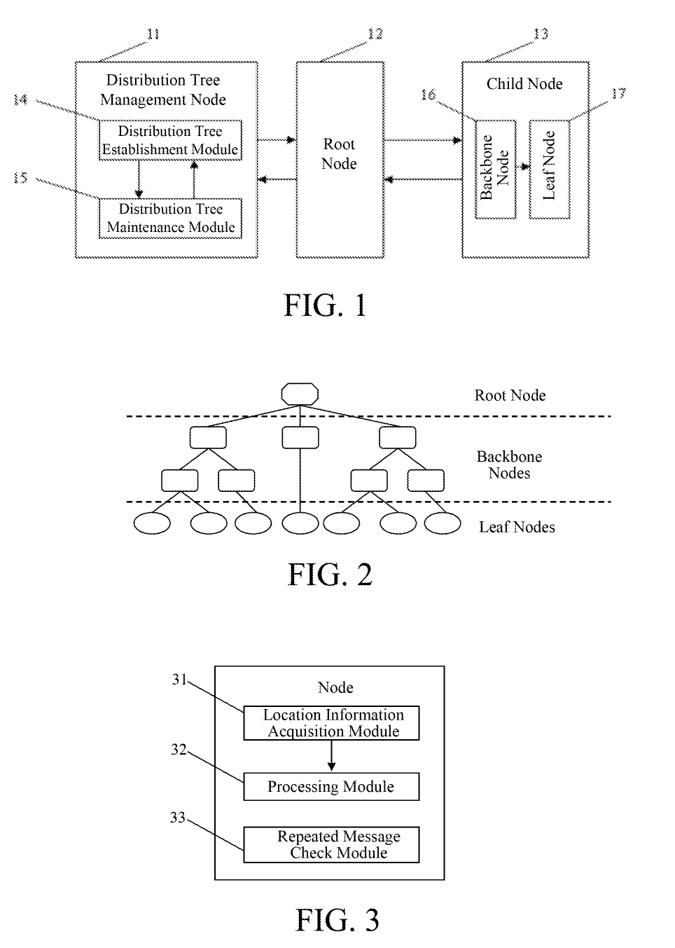

The embodiments of the present disclosure are described in details in conjunction with the accompany drawings. The block diagram of a system for distributing the group key control message in an embodiment of the invention is as shown in FIG. 1. The system includes logically: a root node 12, a distribution tree management node 11, and a child nodes 13.

For a centralized management group key management model, the distribution tree management node 11 is a root node; and for a distributed negotiation group key management model, the distribution tree management node 11 may be a root node 12 for distributing the key control message, or another backbone node 16 or a leaf node 17.

The distribution tree management node 11 is configured to establish a distribution tree for the group key control message within the system, as well as manage and maintain the distribution tree correspondingly. The structure of an embodiment of the distribution tree in an embodiment of the invention is as shown in FIG. 2. The structure of such distribution tree is applicable to both the centralized management group key management model and the distributed negotiation group key management model. The distribution tree includes a root node, at least one backbone node, and leaf nodes intended to be forwarded by the backbone node(s).

The distribution tree management node 11 includes a distribution tree establishment module 14 and a distribution tree maintenance module 15.

The distribution tree establishment module 14 is configured to select a root node and child nodes for the distribution tree, and determine the identity and location of each child node within the distribution tree; inform the identity and location information of a child node to that child node and other child nodes related to the child node, and establish the distribution tree according to the identity and location information of all the child nodes.

The distribution tree maintenance module 15 is configured to maintain the distribution tree established by the distribution tree establishment module, and perform at least one of deletion, addition, and location adjustment for the child nodes in the distribution tree.

The root node 12 corresponds to the dispatcher of the group key control message, such as the group key server in the centralized management group key management method, or the creator of the key control message in the distributed negotiation group key management method. The root node is responsible for delivering the group key control message to the child nodes in the next layer along the distribution tree.

The child nodes 13 receive the group key control message delivered from the root node, and locally process the received group key control message, or concurrently forward it correspondingly. The child nodes include backbone nodes and leaf nodes.

A backbone node 16 receives the group key control message sent from the root node or another backbone node, locally processes the group key control message to extract the related information or key. According to the location of this backbone node within the distribution tree, the received group key control message is replicated by multiple copies and forwarded to the leaf nodes or backbone nodes in the next layer intended to be forwarded by this backbone node.

A leaf node 17 receives the group key control message sent from the root node or a backbone node, and locally processes the group key control message correspondingly without forwarding it to other nodes.

In the above system for distributing the group key control message, in order to control the repeated sending and receipt of the group key control message, the root node may carry a sequence number or time stamp in each delivered group key control message. Upon receiving group key control messages having a repeated sequence number or time stamp, the backbone node or leaf node processes the earlier received group key control message correspondingly and discards the later received group key control message.

An embodiment of the invention further provides a node, configured to distribute a group key control message. The schematic block diagram of an embodiment of the node is as shown in FIG. 3, in which the following modules are included:

a location information acquisition module 31, configured to acquire the location information of this node and its neighboring nodes within the distribution tree for the group key control message;

a process module 32, configured to process the group key control message according to the location information obtained by the location information acquisition module;

where if this node is a root node, the process module is configured to distribute the group key control message to the next layer of this node along the distribution tree;

if this node is a backbone node, the process module is configured to receive the group key control message from the root node or another backbone node, locally process the group key control message to extract the related information or key, replicate and forward the group key control message to the leaf nodes or backbone nodes intended to be forwarded by this backbone node according to the location information obtained by the location information acquisition module; and

if this node is a leaf node, the process module is configured to receive the group key control message from the root node or a backbone node, and locally process the group key control message to extract the related information or key; and

a repeated message check module 33, configured to discard a later received group key control message having a repeated sequence number or a repeated time stamp if the node receives group key control messages having the repeated sequence number or time stamp.

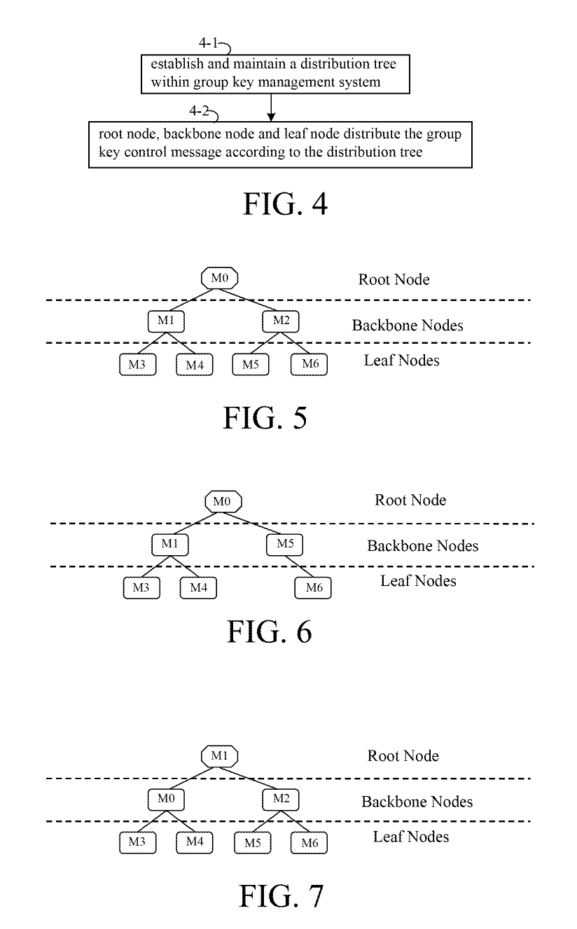

The processing flowchart of a method for distributing a group key control message in an embodiment of the invention is as shown in FIG. 4, including the following steps.

S4-1: A distribution tree is established and maintained within the group key management system.

Primarily, a distribution tree is established and maintained within the group key management system. The establishing of the distribution tree mainly includes: determining a root node first, and then selecting backbone nodes in the next layer and the leaf nodes in the further next layer intended to be forwarded by the backbone nodes according to a preset selection method. Finally, the locations of the backbone nodes and leaf nodes within the distribution tree are determined to form the distribution tree.

The selection methods for the backbone nodes and leaf nodes include, but not limited to:

1. Selecting the earlier registered group member nodes as backbone nodes, and the later registered group member nodes as leaf nodes.

2. Randomly selecting backbone nodes and leaf nodes from the registered group member nodes.

3. Selecting the group member nodes having relatively strong network processing abilities as backbone nodes, and the group member nodes having less strong network processing abilities as leaf nodes.

4. Choosing backbone nodes from volunteer group member nodes, and choosing leaf nodes from non-volunteer group member nodes. The group member nodes each indicates whether it is willing to be a backbone node while registering to the system.

5. Classifying the group member nodes according to the geographical distribution of the group member nodes, and then choosing the backbone nodes and leaf nodes from the group member nodes in the various geographical regions in accordance with the above methods.

6. Integrating the several methods above, for example, selecting the backbone nodes by combining the processing abilities and voluntarism of the nodes; or selecting the earlier registered group member nodes as backbone nodes, and replacing the initial backbone node with a group member node that is found to be with a stronger processing ability in the subsequent running.

After the backbone nodes and leaf nodes are selected, the system may determine the locations of the backbone nodes and leaf nodes within the spanning tree according to certain location allocation method. The location information includes the sub-tree and the layer on which the node is located. The location allocation method may be determining the locations of the various nodes within the distribution tree according to the geographical distribution of the nodes and the connectivity of the nodes with each other.

After allocating the identity (backbone node or leaf node) and location of a group member node, the system needs to inform the information to this group member node as well as group member node(s) related to this group member node, such as the forwarding group member node on the higher layer of this group member node. After the system allocates the identities and locations of all the group member nodes, the final distribution tree is built.

The policy for selecting the height and degree of the spanning tree is determined by the practical usage scenarios and specific technical requirements. For a usage scenario with many group member nodes and insensitive to the key distribution delay, a larger height may be selected for the distribution tree; while if the number of the group member nodes is small or the group member nodes have strong network processing abilities, the degree of the tree may be increased to reduce the number of backbone nodes and the height of the tree, thereby reducing the key distribution delay; and when the group member nodes within a group are in different network conditions, different tree heights and degrees may be determined for the sub-trees formed by the group member nodes in different regions.

S4-2: The root node, backbone nodes and leaf nodes distribute the group key control message according to the distribution tree above.

After the foregoing distribution tree is established within the group key management system, the root node, backbone nodes and leaf nodes distribute the group key control message according to the above distribution tree.

The root node delivers the group key control message to the backbone nodes in the next layer along the distribution tree. Upon receiving the group key control message sent from the root node or another backbone node, the backbone node locally processes the group key control message to extract the related information or key. According to the location of this backbone node within the distribution tree, the received group key control message is replicated by multiple copies and forwarded to the leaf nodes or backbone nodes on the next layer intended to be forwarded by this backbone node.

A leaf node receives the group key control message sent from the root node or a backbone node, and locally processes the group key control message correspondingly without forwarding it to other nodes.

During the above distribution of the group key control message, in order to control the repeated sending and receipt of the group key control message, the root node may carry a sequence number or time stamp in each delivered group key control message. Upon receiving group key control messages having a repeated sequence number or time stamp, the backbone node or leaf node processes the earlier received group key control message correspondingly and discards the later received group key control message(s).

During the running of the system, the distribution tree may be maintained according to the actual conditions. For example, the distribution tree may be adjusted dynamically, and the identities/locations of the backbone nodes and leaf nodes may be switched/changed dynamically according to the situations such as the performance varying or disabling of a node as well as the changing of the network state. For example, a backbone node may be degraded to a leaf node, or a leaf node may be upgraded to a backbone node and the layer thereof within the distribution tree may be promoted. The system is required to notify the corresponding group members after each adjustment for the distribution tree, for example, if a leaf node leaves, the system informs the forwarding node on higher layer used to forward the key control message to the leaf node.

The establishment and maintenance for the distribution tree are accomplished by a particular group controller or a group member node playing the role of a group controller, wherein the group member node may be a distribution tree establishment node. For a centralized management group key management model, the distribution tree establishment node is the root node. For a distributed negotiation group key management model, the distribution tree establishment node may be the root node or a child node.

During the maintenance for the distribution tree, it is to be considered that the height, degree and stability of the distribution tree will affect the performance of the distribution tree. For example, the increase of the height of the tree increases the distribution delay and increases the difficulty for maintaining the tree; the increase of the degree of the tree may reduce the height of the tree, but increase the workload of replication and forwarding of the backbone nodes. The frequent variation of the distribution tree also causes the instability of the system, and decreases the performance of the distribution tree as well.

The management message for the distribution tree itself, e.g. the management message for establishing and maintaining the distribution tree, would make sure that only the group controller may operate the distribution tree through an authentication mechanism of digital signature or Medium Access Control (MAC) layer, etc. Furthermore, the management message for the distribution tree may also incorporate an anti-replay mechanism such as the sequence number or time stamp, to prevent the attackers from modifying the current distribution tree by viciously utilizing a previously intercepted management message.

The systems and methods of the foregoing embodiments of the invention may be deployed separately, or be used in connection with other schemes.

For a situation where the multicast service is locally available, e.g., a Wireless Local Area Network (WLAN), a unique backbone node may be provided for the group member nodes within the local area. The group key control message is distributed to the backbone node from the root node according to the distribution tree, and then distributed to other leaf nodes by the backbone node by terms of multicast. For a situation where the multicast service is locally unavailable, a backbone node may be provided within another multicast available area neighboring to this local area, and the key message is distributed to this local area by this backbone node, while a plurality of backbone nodes may be provided within the local region as desired.

The structure of a distribution tree in a specific application instance of the system of an embodiment of the invention is as shown in FIG. 4.

In the specific application instance of the centralized management group key management model, M0 is a key server as well as a group controller in a secure group, having the capability of distributing a key and formulating a group policy, and M1, M2, . . . , M6 are group members joining this secure group in sequence. As shown in FIG. 4, the group controller selects M1 and M2 who join the secure group earlier as backbone nodes, and selects the later joined M3, M4, M5 and M6 as leaf nodes. M3 and M4 have established secure session channels with M1 before joining the secure group, such as a Transport Layer Security (TLS) channel, and M5, M6 and M2 are in the same sub-network.

During the establishment of the spanning tree, M0 notifies M1 to forward the key control message for M3 and M4, instructs M2 to forward the key control message for M5 and M6, and distributes the corresponding forwarding table to M1 and M2. While distributing the key control message, M0 primarily sends the message to M1 and M2, then M1 and M2 process and replicate the message respectively according to the forwarding table before sending it to the corresponding leaf nodes.

After the backbone node M2 leaves the secure group, M0 needs to adjust the structure of the distribution tree shown in FIG. 4, and the structure of the adjusted distribution tree is as shown in FIG. 5. M0 selects the earlier joined M5 as a backbone node, and instructs M5 to provide message forwarding for M6.

The structure of a distribution tree in another specific application instance of the system of an embodiment of the invention is as shown in FIG. 6.

In the specific application instance of a distributed group key management model, all the group members participate in the key negotiation. For example, there are 7 group members M0, M1, . . . , M6 in the secure group, with M0 being the distribution tree establishment node responsible for establishing the distribution tree system and providing maintenance. M0 informs M1 who joins the group later as the root node of the distribution tree, and M0 specifies M3 and M4 as its own leaf nodes, while M2 forwards the key control message for M5 and M6 as a backbone node. Thus, each group member from M0 to M6 sends part contribution value to the root node M1, which receives the contribution values sent from all the group members and distributes the group key control message carrying all the contribution values to all the group members in sequence via the distribution tree built by M0. Then the group members each calculate the group key.

Similar to the centralized management group key management model, M0 maintains the key tree according to a local mechanism. After a group member leaves the group, M0 builds a new key distribution tree, and notifies the remaining group members to update the key, i.e. M0 initiates the key negotiation of a new round.

In the specific application instance of the foregoing distributed group key management model, the child node M0 acts as the distribution tree establishment node, while in the practical applications, the root node may be the distribution tree establishment node.

As described above, the embodiments of the present disclosure proposes a new scheme for distributing the group key control message, so that group key management system does not depend on whether the deployed environment provides the multicast service by integrating a multicast mechanism within the group key management system, thereby promoting the availability, expandability and efficiency of the group key management system. The usage of the system facility is improved by allowing the group member nodes to participate in the distribution of the group key control message.

The foregoing are merely exemplary embodiments of the present disclosure, while the scope of the present disclosure is not so limited. Any variations or equivalents that will be readily conceived by those skilled in the art from the technical scope disclosed by the present disclosure are intended to be embraced within the scope of the present disclosure. Therefore, the scope of the present disclosure should be construed as the scope of the claims.

What is claimed is:

1. A system for distributing a group key control message, comprising:
a distribution tree management node (11), configured to establish a distribution tree for the group key control message within the system, as well as manage and maintain the distribution tree correspondingly;
a root node (12), configured to deliver the group key control message to a child node according to the distribution tree for the group key control message; and
a child node (13), configured to receive the group key control message delivered from the root node and process the received group key control message.

2. The system of claim 1, wherein the distribution tree management node comprises:
a distribution tree establishment module (14), configured to select a root node and child nodes for the distribution tree, determine identities and locations of the respective child nodes within the distribution tree, inform the identity and location of a respective child node to the child node and other child nodes related to the child node, and establish the distribution tree according to the identities and locations of all the child nodes; and
a distribution tree maintenance module (15), configured to perform maintenance operations on the distribution tree, the maintenance operations comprising at least one of deleting a child node, adding a child node, and adjusting a location of a child node.

3. The system of claim 2, wherein the distribution tree establishment node is at a root node of a centralized management group key management model.

4. The system of claim 1, wherein the child nodes comprises:
a backbone node (16), configured to receive the group key control message sent from the root node or another backbone node, locally process the group key control message; replicate the received group key control message by multiple copies according to the distribution tree and forward the group key control message to a leaf node or a backbone node intended to be forwarded by the backbone node; and
a leaf node (17), configured to receive the group key control message sent from the root node or the backbone node, and locally process the group key control message.

5. The system of claim 2, wherein the child nodes comprises:
a backbone node (16), configured to receive the group key control message sent from the root node or another backbone node, locally process the group key control message; replicate the received group key control message by multiple copies according to the distribution tree and forward the group key control message to a leaf node or a backbone node intended to be forwarded by the backbone node; and
a leaf node (17), configured to receive the group key control message sent from the root node or the backbone node, and locally process the group key control message.

6. The system of claim 3, wherein the child nodes comprises:
a backbone node (16), configured to receive the group key control message sent from the root node or another backbone node, locally process the group key control message; replicate the received group key control message by multiple copies according to the distribution tree and forward the group key control message to a leaf node or a backbone node intended to be forwarded by the backbone node; and
a leaf node (17), configured to receive the group key control message sent from the root node or the backbone node, and locally process the group key control message.

7. A method for distributing a group key control message, comprising establishing a distribution tree for the group key control message, further comprising:
delivering, by a root node, the group key control message to a child node according to the distribution tree; and
receiving, by the child node, the group key control message delivered from the root node and processing the received group key control message.

8. The method of claim 7, wherein the establishing of the distribution tree for the group key control message comprises:
selecting the root node and child nodes for the distribution tree, and determining identities and locations of the respective child nodes within the distribution tree; and
informing the identity and location of a child node to the child node and other child nodes related to the child node, and establishing the distribution tree according to the identities and locations of all the child nodes.

9. The method of claim 7, wherein, the delivering of the group key control message to the child node according to the distribution tree comprises:
creating, by the root node, the group key control message, and delivering the group key control message to the child node according to the distribution tree; or,
creating, by the child node, a group key control message carrying a contribution value of the child node, and sending the group key control message to the root node; receiving, by the root node, the contribution values sent from all group members, creating the group key control message carrying all the contribution values, and delivering the group key control message to all the group members via the distribution tree.

10. The method of claim 7, wherein the child node comprises a backbone node and a leaf node, wherein,
the backbone node is configured to receive the group key control message sent from the root node or another backbone node, locally process the group key control message, replicate the received group key control message by multiple copies and forward the group key control message to a leaf node or a backbone node intended to be forwarded by the backbone node; and
the leaf node is configured to receive the group key control message sent from the root node or the backbone node, and locally process the group key control message.

11. The method of claim 8, wherein the child node comprises a backbone node and a leaf node, wherein,
the backbone node is configured to receive the group key control message sent from the root node or another backbone node, locally process the group key control message, replicate the received group key control message by multiple copies and forward the group key control message to a leaf node or a backbone node intended to be forwarded by the backbone node; and
the leaf node is configured to receive the group key control message sent from the root node or the backbone node, and locally process the group key control message.

12. The method of claim 9, wherein the child node comprises a backbone node and a leaf node, wherein,
the backbone node is configured to receive the group key control message sent from the root node or another backbone node, locally process the group key control message, replicate the received group key control message by multiple copies and forward the group key control message to a leaf node or a backbone node intended to be forwarded by the backbone node; and
the leaf node is configured to receive the group key control message sent from the root node or the backbone node, and locally process the group key control message.

13. The method of claim 8, wherein the child nodes comprises a backbone node and a leaf node, and the selecting of the child nodes for the distribution tree and determining the identities and locations of the child nodes within the distribution tree comprises:
selecting a earlier registered group member node as the backbone node, and a later registered group member node as the leaf node; or
randomly selecting the backbone node and the leaf node from registered group member nodes; or
selecting a volunteer group member node as the backbone node, and selecting a non-volunteer group member node as the leaf node, each group member node indicating whether it is a volunteer group member node while registering to the system; or
selecting the backbone node and the leaf node according to network processing abilities of the group member nodes; or
selecting the backbone node and the leaf node according to geographical distribution of the group member nodes.

14. The method of claim 10, further comprising:
carrying a sequence number or a time stamp in each group key control message, and discarding a later received group key control message having a repeated sequence number or time stamp if the backbone node or leaf node receives group key control messages having the repeated sequence numbers or time stamps.

15. A node for managing a distribution tree for a group key control message, comprising:
a distribution tree establishment module (14), configured to select a root node and child nodes for the distribution tree, determine identity and location of each child node within the distribution tree, inform identity and location information of a child node to the child node and child nodes related to the child node, and establish the distribution tree according to the identity and location information of all the child nodes; and
a distribution tree maintenance module (15), configured to perform a maintenance operation on the distribution tree, the maintenance operation comprising at least one of deleting a child node, adding a child node, and adjusting location of a child node.

16. A node for distributing a group key control message, comprising:
a location information acquisition module (31), configured to acquire location information of the node and its neighboring nodes within a distribution tree for the group key control message; and
a process module (32), configured to process the group key control message according to the location information obtained by the location information acquisition module.

17. The node of claim 16, wherein:
if the node is a root node, the process module delivers the group key control message to a next layer of the node along the distribution tree;
if the node is a backbone node, the process module receives the group key control message from a root node or another backbone node, locally processes the group key control message to extract related information or key, replicates and forwards the group key control message to a leaf node or a backbone node intended to be forwarded by the process module according to the location information obtained by the location information acquisition module; and
if the node is a leaf node, the process module receives the group key control message from a root node or a backbone node, and locally processes the group key control message to extract related information or key.

18. The node of claim 16, further comprising:
a repeated message check module (33), configured to discard a later received group key control message having a repeated sequence number or time stamp if the node receives group key control messages having the repeated sequence number or time stamp.

19. The node of claim 17, further comprising:
a repeated message check module (33), configured to discard a later received group key control message having a repeated sequence number or time stamp if the node receives group key control messages having the repeated sequence number or time stamp.
